(19) United States
(12) Patent Application Publication
(10) Pub. No.: US 2015/0380032 A1
(43) Pub. Date: Dec. 31, 2015

(54) SYSTEMS AND METHODS FOR WRITING DATA TO BOTH SIDES OF SEQUENTIAL STORAGE MEDIA

(71) Applicant: Dell Products L.P., Round Rock, TX (US)

(72) Inventors: Elizabeth A. McTeer, Austin, TX (US); Randy M. Ortiz, Austin, TX (US)

(21) Appl. No.: 14/318,080

(22) Filed: Jun. 27, 2014

(51) Int. Cl. G11B 5/48; G11B 15/18; G11B 5/54

(52) U.S. Cl. CPC G11B 5/4893; G11B 5/54; G11B 15/18

(57) ABSTRACT

In accordance with embodiments of the present disclosure, a sequential storage media system for writing to both sides of a sequential storage medium, may include a first head and a second head. The first head may be configured to maintain contact with a first side of the sequential storage medium and read data from and/or write data to the first side as the sequential storage medium is wound between reels for winding the sequential storage medium. The second head may be configured to maintain contact with a second side of the sequential storage medium and read data from and/or write data to the second side as the sequential storage medium is wound between reels for winding the sequential storage medium.

### TECHNICAL FIELD

The present disclosure relates in general to information handling systems, and more particularly to systems and methods for writing data to both sides of sequential storage media.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Sequential storage media, also known as tape media, may comprise a reel of a magnetic strip of material in which a magnetic write head is used to write data on the media. In traditional sequential storage media drives, data can only be written to one side of the storage media. Thus, the other side of the storage media goes unused from the standpoint of storing data.

Due to the increase of data that users desire to store, it would be beneficial to store data on both sides of sequential storage media, while maintaining backwards compatibility with existing approaches to storing data to sequential storage media.

### SUMMARY

In accordance with the teachings of the present disclosure, the disadvantages and problems associated with writing data to both sides of sequential storage media may be reduced or eliminated.

In accordance with embodiments of the present disclosure, a sequential storage media system for writing to both sides of a sequential storage medium, may include a first head and a second head. The first head may be configured to maintain contact with a first side of the sequential storage medium and read data from and/or write data to the first side as the sequential storage medium is wound between reels for winding the sequential storage medium. The second head may be configured to maintain contact with a second side of the sequential storage medium and read data from and/or write data to the second side as the sequential storage medium is wound between reels for winding the sequential storage medium.

In accordance with these and other embodiments of the present disclosure, a method for writing to both sides of a sequential storage medium may comprise maintaining contact between a first head and a first side of the sequential storage medium and writing data to the first side as the sequential storage medium is wound between reels for winding the sequential storage medium. The method may also include maintaining contact between a second head and a second side of the sequential storage medium and writing data to the second side as the sequential storage medium is wound between reels for winding the sequential storage medium.

In accordance with these and other embodiments of the present disclosure, an information handling system may include a processor and a sequential storage media system for writing to both sides of a sequential storage medium. The sequential storage media system may comprise a first head and a second head. The first head may be configured to maintain contact with a first side of the sequential storage medium and read data from and/or write data to the first side as the sequential storage medium is wound between reels for winding the sequential storage medium. The second head may be configured to maintain contact with a second side of the sequential storage medium and read data from and/or write data to the second side as the sequential storage medium is wound between reels for winding the sequential storage medium.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example information handling system, in accordance with embodiments of the present disclosure;

FIGS. 2A and 2B illustrate a plan view of selected components of an example sequential storage media system, in accordance with embodiments of the present disclosure; and

FIGS. 3A and 3B illustrate a plan view of selected components of an example sequential storage media system, in accordance with embodiments of the present disclosure.

### DETAILED DESCRIPTION

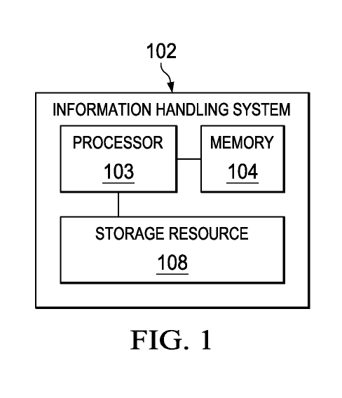

Preferred embodiments and their advantages are best understood by reference to FIGS. 1 through 3B, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

FIG. 1 illustrates a functional block diagram of selected components of an example information handling system 102, in accordance with embodiments of the present disclosure. In some embodiments, information handling system 102 may be a personal computer (e.g., a desktop computer or a portable computer). In other embodiments, information handling system 102 may comprise a storage server for archiving data.

As depicted in FIG. 1, information handling system 102 may include a processor 103, a memory 104 communicatively coupled to processor 103, and a storage resource 108 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, storage resource 108, and/or another component of information handling system 102.

Memory 104 may be communicatively coupled to processor 103 and may include any system, device, or apparatus configured to retain program instructions and/or data for a period of time (e.g., computer-readable media). Memory 104 may include random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to its associated information handling system 102 is turned off.

Storage resource 108 may include a system, device, or apparatus configured to store data. Storage resource 108 may include one or more hard disk drives, magnetic tape libraries, optical disk drives, magneto-optical disk drives, solid state storage drives, compact disk drives, compact disk arrays, disk array controllers, and/or any other systems, apparatuses or devices configured to store data. In certain embodiments, storage resource 108 may include one or more storage enclosures configured to hold and/or power one or more of such devices. In the embodiments represented by FIG. 1, storage resource 108 may reside within information handling system 102. However, in other embodiments, storage resource 108 may reside external to information handling system 102 (e.g., may be coupled to information handling system 102 via a network).

In particular embodiments, storage resource 108 may comprise a sequential storage media system. A sequential storage media system may comprise any system, device, or apparatus for storing or recording information on sequential storage media (e.g., magnetic tape). Such sequential storage media may be packaged in cartridges or cassettes.

In addition to processor 103, memory 104, and storage resource 108, information handling system 102 may include one or more other information handling resources. Such an information handling resource may include any component system, device or apparatus of an information handling system, including without limitation, a processor, bus, memory, I/O device and/or interface, storage resource (e.g., hard disk drives), network interface, electro-mechanical device (e.g., fan), display, power supply, and/or any portion thereof. An information handling resource may comprise any suitable package or form factor, including without limitation an integrated circuit package or a printed circuit board having mounted thereon one or more integrated circuits.

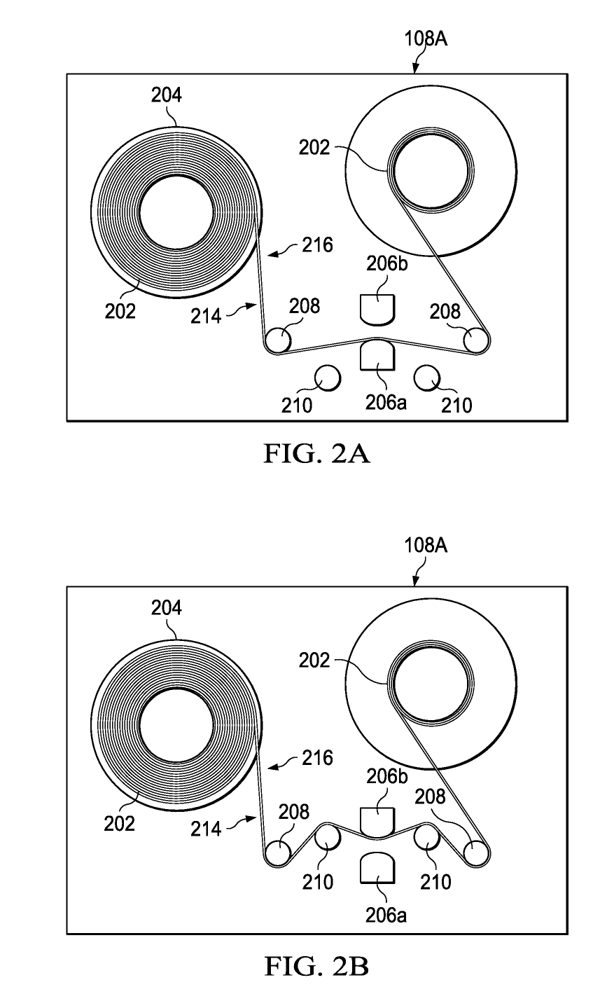

FIGS. 2A and 2B illustrate a plan view of selected components of an example sequential storage media system 108A, in accordance with embodiments of the present disclosure. Sequential storage media system 108A may be used as, or as part of, storage resource 108 of information handling system 102 of FIG. 1. As shown in FIGS. 2A and 2B, sequential storage media system 108A may comprise two reels 202, sequential storage media 204, read/write heads 206 (e.g., 206a and 206b), fixed guides 208, and movable guides 210.

Each reel 202 may comprise any suitable system, device, or apparatus for carrying sequential storage media 204, and winding sequential storage media 204 between reels 202. Accordingly, one or both of reels 202 may include or be configured to couple to mechanical parts (e.g., motors) for driving one or both reels 202 in a rotational manner in order to wind sequential storage media 204 from one reel to another.

Sequential storage media 204 may comprise a tape of magnetic material for magnetic recording. For example, sequential storage media 204 may comprise a long, narrow strip of plastic film which is coated on at least one side 214, 216 with a thin magnetizable coating. If coated on both sides 214 and 216 with magnetizable coating, such sequential storage media 204 may support recording separate data on each side 214, 216 of the plastic film, and thus functions as dual-sided sequential storage media.

As sequential storage media 204 is translated between reels 202, continuous portions of sequential storage media 204 may come in contact with head 206a or 206b. A head 206 may comprise any system, device, or apparatus configured to read data from and/or write data to sequential storage media 204 as continuous portions of sequential storage media 204 pass over such head 206 by modifying the magnetization of such sequential storage media 204 in accordance with the information to be written. In some embodiments, a head 206 may comprise a read/write head which is also capable of reading data from sequential storage media 204 by detecting the magnetization of sequential storage media 204. As shown in FIG. 2A, when side 214 of sequential storage media 204 is in contact with head 206a, head 206a may read data from and/or write data to side 214. Similarly, when side 216 of sequential storage media 204 is in contact with head 206b, head 206b may read data from and/or write data to side 216.

In order to guide sequential storage media 204 to contact a head 206 as it is wound between reels 202, sequential storage media system 108A may include fixed guides 208 and movable guides 210. One or more of fixed guides 208 and movable guides 210 may be capable of rotation about an axis (e.g., wherein such axis is perpendicular to the view shown in FIGS. 2A and 2B) such that guides 208 and/or 210 may rotate as sequential storage media 204 passes over them, thus facilitating the winding of sequential storage media 204 as it passes over a head 206. A fixed guide 208, while capable of rotating about an axis, may otherwise remain fixed in the sense that a fixed guide 208 will remain generally fixed in position in directions perpendicular to its axis. On the other hand, a movable guide 210 may be configured to move relative to other components of sequential storage media system 108A between a first position, as shown in FIG. 2A, to a second position, as shown in FIG. 2B, and vice versa.

In the first position of movable guides 210, sequential storage media 204 may come in contact with fixed guides 208 in a manner in which fixed guides 208 create a mechanical tension causing side 214 of sequential storage media 204 to come in physical contact with head 206a as sequential storage media 204 is wound between reels 202. Thus, when movable guides 210 are in the first position, sequential storage media system 108A may read data from and/or write data to first side 214 of sequential storage media 204.

On the other hand, in the second position of movable guides 210, sequential storage media 204 may come in contact with movable guides 210 in a manner in which movable guides 210 create a mechanical tension causing side 216 of sequential storage media 204 to come in physical contact with head 206b as sequential storage media 204 is wound between reels 202. Thus, when movable guides 210 are in the second position, sequential storage media system 108A may read data from and/or write data to second side 216 of sequential storage media 204.

The movement of movable guides 210 between the first position and the second position may be carried out in any suitable manner. For example, in some embodiments, such movement may take place by way of mechanical motors coupled to movable guides 210 which are under the control of firmware or logic integral to sequential storage media system 108A.

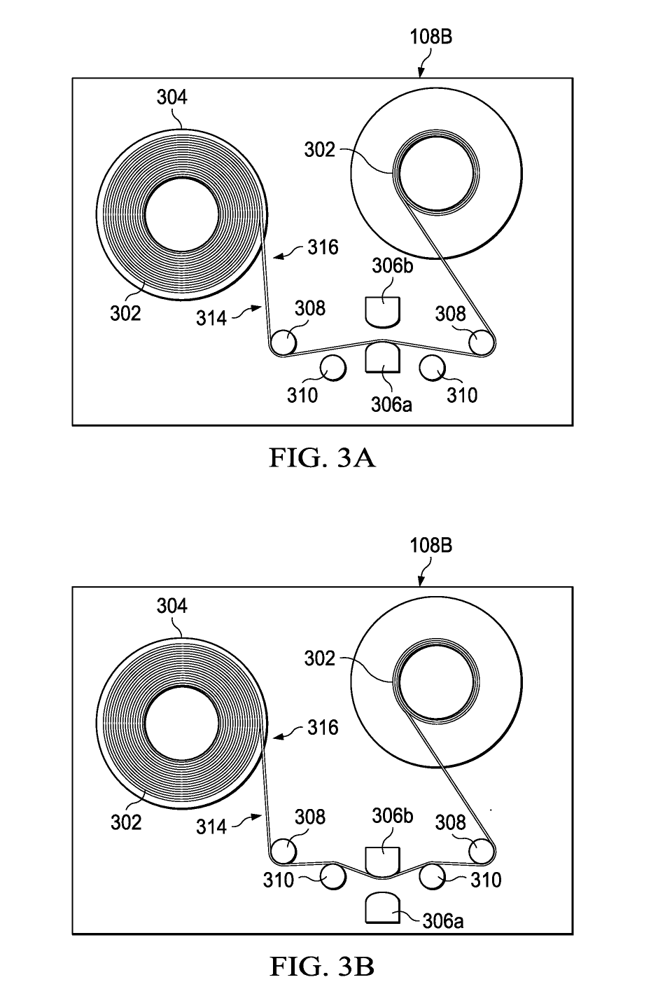

FIGS. 3A and 3B illustrate a plan view of selected components of an example sequential storage media system 108B, in accordance with embodiments of the present disclosure. Sequential storage media system 108B may be used as, or as part of, storage resource 108 of information handling system 102 of FIG. 1. As shown in FIGS. 3A and 3B, sequential storage media system 108B may comprise two reels 302, sequential storage media 304, read/write heads 306 (e.g., 306a and 306b), guides 308, and guides 310.

Each reel 302 may comprise any suitable system, device, or apparatus for carrying sequential storage media 304, and winding sequential storage media 304 between reels 302. Accordingly, one or both of reels 302 may include or be configured to couple to mechanical parts (e.g., motors) for driving one or both reels 302 in a rotational manner in order to wind sequential storage media 304 from one reel to another.

Sequential storage media 304 may comprise a tape of magnetic material for magnetic recording. For example, sequential storage media 304 may comprise a long, narrow strip of plastic film which is coated on at least one side 314, 316 with a thin magnetizable coating. If coated on both sides 314 and 316 with magnetizable coating, such sequential storage media 304 may support recording separate data on each side 314, 316 of the plastic film, and thus functions as dual-sided sequential storage media.

As sequential storage media 304 is translated between reels 302, continuous portions of sequential storage media 304 may come in contact with head 306a or 306b. A head 306 may comprise any system, device, or apparatus configured to read data from and/or write data to sequential storage media 304 as continuous portions of sequential storage media 304 pass over such head 306 by modifying the magnetization of such sequential storage media 304 in accordance with the information to be written. In some embodiments, a head 306 may comprise a read/write head which is also capable of reading data from sequential storage media 304 by detecting the magnetization of sequential storage media 304. As shown in FIG. 3A, when side 314 of sequential storage media 304 is in contact with head 306a, head 306a may read data from and/or write data to side 314. Similarly, when side 316 of sequential storage media 304 is in contact with head 306b, head 306b may read data from and/or write data to side 316.

In order to guide sequential storage media 304 to contact a head 306 as it is wound between reels 302, sequential storage media system 108B may include guides 308 and guides 310. One or more of guides 308 and guides 310 may be capable of rotation about an axis (e.g., wherein such axis is perpendicular to the view shown in FIGS. 3A and 3B) such that guides 308 and/or 310 may rotate as sequential storage media 304 passes over them, thus facilitating the winding of sequential storage media 304 as it passes over a head 306.

In the embodiments represented by FIGS. 3A and 3B, each head 306 may be configured to move relative to other components of sequential storage media system 108B between a first position, as shown in FIG. 3A, to a second position, as shown in FIG. 3B, and vice versa. In the first position of heads 306, sequential storage media 304 may come in contact with guides 308 in a manner in which guides 308 create a mechanical tension causing side 314 of sequential storage media 304 to come in physical contact with head 306a as sequential storage media 304 is wound between reels 302. Thus, when heads 306 are in the first position, sequential storage media system 108B may read data from and/or write data to first side 314 of sequential storage media 304.

On the other hand, in the second position of heads 306, sequential storage media 304 may come in contact with guides 310 in a manner in which guides 310 create a mechanical tension causing side 316 of sequential storage media 304 to come in physical contact with head 306b as sequential storage media 304 is wound between reels 302. Thus, when heads 306 are in the second position, sequential storage media system 108B may read data from and/or write data to second side 316 of sequential storage media 304.

The movement of heads between the first position and the second position may be carried out in any suitable manner. For example, in some embodiments, such movement may take place by way of mechanical motors coupled to heads which are under the control of firmware or logic integral to sequential storage media system 108B.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

1. (canceled)

2. A sequential storage media system for writing to both sides of a sequential storage medium, comprising:
a first head configured to maintain contact with a first side of the sequential storage medium and read data from and/or write data to the first side as the sequential storage medium is wound between reels for winding the sequential storage medium; and
a second head configured to maintain contact with a second side of the sequential storage medium and read data from and/or write data to the second side as the sequential storage medium is wound between reels for winding the sequential storage medium; wherein the first head and the second head are each movable relative to the sequential storage medium in a direction substantially perpendicular to a portion of the sequential storage medium adjacent to the first head and the second head between a first position and a second position and vice versa, wherein:
in the first position, the first head maintains contact with the sequential storage medium; and
in the second position, the second head maintains contact with the sequential storage medium.

3. The sequential storage media system of claim 2, further comprising a first pair of guides and a second pair of guides, wherein:
in the first position, the first pair of guides creates mechanical tension causing the first side to maintain contact with the first head; and
in the second position, the second pair of guides creates mechanical tension causing the second side to maintain contact with the second head.

4. The sequential storage media system of claim 3, wherein the first pair of guides and second pair of guides are fixed, and the first head and the second head are movable relative to the first pair of guides and the second pair of guides.

5. A sequential storage media system for writing to both sides of a sequential storage medium, comprising:
a first head configured to maintain contact with a first side of the sequential storage medium and read data from and/or write data to the first side as the sequential storage medium is wound between reels for winding the sequential storage medium;
a second head configured to maintain contact with a second side of the sequential storage medium and read data from and/or write data to the second side as the sequential storage medium is wound between reels for winding the sequential storage medium; and
a first pair of guides and a second pair of guides, wherein:
each of the second pair of guides is movable, other than by rotational movement of the second pair of guides, relative to the sequential storage medium and the first pair of guides between a first position and a second position and vice versa;
in the first position, the first pair of guides creates mechanical tension causing the first side to maintain contact with the first head; and
in the second position, the second pair of guides creates mechanical tension causing the second side to maintain contact with the second head.

6. (canceled)

7. A method for writing to both sides of a sequential storage medium, comprising:
maintaining contact between a first head and a first side of the sequential storage medium and writing data to the first side as the sequential storage medium is wound between reels for winding the sequential storage medium;
maintaining contact between a second head and a second side of the sequential storage medium and writing data to the second side as the sequential storage medium is wound between reels for winding the sequential storage medium; and
moving the first head and the second head relative to the sequential storage medium in a direction substantially perpendicular to a portion of the sequential storage medium adjacent to the first head and the second head between a first position and a second position and vice versa, wherein:
in the first position, the first head maintains contact with the sequential storage medium; and
in the second position, the second head maintains contact with the sequential storage medium.

8. The method of claim 7, further comprising:
in the first position, creating mechanical tension with a first pair of guides causing the first side to maintain contact with the first head; and
in the second position, creating mechanical tension with a second pair of guides causing the second side to maintain contact with the second head.

9. The method of claim 8, wherein the first pair of guides and second pair of guides are fixed, and the first head and the second head are movable relative to the first pair of guides and the second pair of guides.

10.-11. (canceled)

12. An information handling system comprising:
a processor; and
a sequential storage media system for writing to both sides of a sequential storage medium, comprising:
a first head configured to maintain contact with a first side of the sequential storage medium and read data from and/or write data to the first side as the sequential storage medium is wound between reels for winding the sequential storage medium; and
a second head configured to maintain contact with a second side of the sequential storage medium and read data from and/or write data to the second side as the sequential storage medium is wound between reels for winding the sequential storage medium;
wherein the first head and the second head are each movable relative to the sequential storage medium in a direction substantially perpendicular to a portion of the sequential storage medium adjacent to the first head and the second head between a first position and a second position and vice versa, wherein:
in the first position, the first head maintains contact with the sequential storage medium; and
in the second position, the second head maintains contact with the sequential storage medium.

13. The information handling system of claim 12, further comprising a first pair of guides and a second pair of guides, wherein:
in the first position, the first pair of guides creates mechanical tension causing the first side to maintain contact with the first head; and
in the second position, the second pair of guides creates mechanical tension causing the second side to maintain contact with the second head.

14. The information handling system of claim 13, wherein the first pair of guides and second pair of guides are fixed, and the first head and the second head are movable relative to the first pair of guides and the second pair of guides.

15. (canceled)
